(19) United States
(12) Patent Application Publication
(10) Pub. No.: US 2008/0111482 A1
(43) Pub. Date: May 15, 2008

(54) Active matrix organic light emitting display and method for fabricating same

(75) Inventors: Jung-Lung Huang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/985,260

(22) Filed: Nov. 13, 2007

(30) Foreign Application Priority Data
Nov. 10, 2006 (TW) 95141768

(51) Int. Cl. H01J 63/04

(52) U.S. Cl. 313/504

(57) ABSTRACT

An exemplary active matrix organic light emitting display (OLED) (20) includes a transparent insulating substrate (200), a thin film transistor (TFT) structure (210) formed on the transparent insulating substrate, and an organic emission structure (220) formed on the transparent insulating substrate. The TFT structure includes a source electrode (216), a drain electrode (217), and a passivation layer configured as a cathode inter-insulator (318). The passivation layer covers the source electrode and a portion of the drain electrode. The organic emission structure is formed on the other portion of the drain electrode.

### FIELD OF THE INVENTION

The present invention relates to organic light emitting displays (OLEDs), particularly to an active matrix OLED and a method for fabricating the active matrix OLED.

### GENERAL BACKGROUND

Organic light emitting displays (OLEDs) provide images with high brightness and a wide viewing angle. Because OLEDs are self-luminous, they do not require backlights, and can be effectively used even in relatively dark environments. OLEDs can be categorized into two kinds: active matrix OLEDs and passive matrix OLEDs.

Referring to FIG. 11, a typical active matrix OLED 10 includes a transparent insulating substrate 100 defining a thin film transistor (TFT) region 101 and an organic emission region 102, a TFT structure 120 corresponding to the TFT region 101, and an organic emission structure 140 corresponding to the organic emission region 102.

The TFT structure 120 includes a doped semiconductor layer 121, a first insulating layer 122, a gate electrode 123, a second insulating layer 124, a source electrode 125, a drain electrode 126, and a passivation layer 127. The doped semiconductor layer 121 is strip-shaped, and is disposed on the TFT region 101. The first insulating layer 122 covers the doped semiconductor layer 121 and the transparent insulating substrate 100. The gate electrode 123 is formed on a portion of the first insulating layer 122 that corresponds to the doped semiconductor layer 121. The second insulating layer 124 covers the gate electrode 123 and the first insulating layer 122.

The first insulating layer 122 and the second insulating layer 124 cooperatively define a first contact hole 151 and a second contact hole 153 therethrough. Thereby, the first and second contact holes 151, 153 expose two parts of the doped semiconductor 121, respectively. The source electrode 125 and the drain electrode 126 fill the two contact holes 151, 153, respectively, and each of the source and drain electrodes 125, 126 overlaps a respective portion of the second insulating layer 124. The source electrode 125 and the drain electrode 126 are electrically connected with the doped semiconductor layer 121. The passivation layer 127 covers the source electrode 125, the drain electrode 126, and the second insulating layer 124. The passivation layer 127 has a smooth upper surface, and defines a third contact hole 155. The third contact hole 155 exposes a part of the drain electrode 126.

The organic emission structure 140 includes a cathode inter insulator 141, a transparent anode electrode layer 142, a metal reflective layer 143, a hole injection layer (HIL) 144, an organic emission layer (EL) 145, an electron injection layer (EIL) 146, a cathode 147, and a transparent electrode layer 148, arranged in that order from bottom to top. The transparent anode electrode layer 142 covers the passivation layer 147, and is electrically connected with the drain electrode 126 in the third contact hole 155. The metal reflective layer 143 is a thin metal film, having a high reflective ratio, which is formed on the transparent anode electrode layer 142 through a sputtering method. The cathode 147 is also formed through the sputtering method, which is a transparent thin metal film. The cathode 147 is made from argentums material or aluminium material, having a thickness less than 10 nm. The transparent anode electrode layer 142 and the transparent electrode layer 148 can be made from indium tin oxide (ITO) or indium zinc oxide (IZO).

The cathode inter-insulator 141 is generally T-shaped in cross-section. A vertical portion of the cathode inter-insulator 141 fills in the third contact hole 155, and a horizontal top portion covers a part of the metal reflective layer 143, having a trapezia shape. A thickness of a horizontal top portion of the cathode inter-insulator 141 is substantially equal to a combined thickness of the HIL 144, the EL 145, the EIL 146, the cathode 147, and the transparent electrode layer 148.

When a voltage is provided on the active matrix OLED 10, the HIL 144 and the EIL 146 respectively inject electric holes and electrons into the EL 145 for hole-electron combination. Energy released in the process of hole-electron recombination can excite the molecules of the EL 145 and emit photons. One part of this light then escapes through the EIL 146, the cathode 147, and the transparent electrode layer 148 where the viewer can observe it; and another part of this light is reflected by the metal reflective layer 143.

However, for obtaining a top emission mode OLED, the cathode 147 needs to be a metal thin film, which is translucency. Thus, the luminance of the active matrix OLED 10 is reduced. In addition, the active matrix OLED 10 needs a fabricating process to form a third contact hole 155 for connecting the anode 142 with the drain electrode 126 of the TFT 120. Furthermore, the passivation layer 127 and the cathode inter-insulator 141 are two separate parts. Therefore two separate fabricating steps are needed to form the passivation layer 127 and the cathode inter-insulator 141. Thus the structure of the active matrix OLED 10 is somewhat complicated, and the method of fabricating the active matrix OLED 10 is correspondingly complicated.

What is needed, therefore, is a new active matrix OLED that can overcome the above-described problems. What is also needed is a method for fabricating the active matrix OLED that can overcome the above-described problems.

### SUMMARY

In one aspect, an exemplary active matrix organic light emitting display (OLED) includes a transparent insulating substrate, a thin film transistor (TFT) structure formed on the transparent insulating substrate, and an organic emission structure formed on the transparent insulating substrate. The TFT structure includes a source electrode, a drain electrode, and a passivation layer configured as a cathode inter-insulator. The passivation layer covers the source electrode and a portion of the drain electrode. The organic emission structure is formed on the other portion of the drain electrode.

In another aspect, an exemplary method for fabricating an active matrix organic light emitting display (OLED), the method including: providing a transparent insulating substrate; forming a thin film transistor (TFT) structure and an organic emission structure on the transparent insulating substrate. In the process of forming the TFT structure having steps of forming a source electrode and a drain electrode, and forming a passivation layer covering the source electrode and a portion of the drain electrode. The organic emission structure is formed on the other portion of the drain electrode.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an equivalent circuit diagram of part of an active matrix organic light emitting display (OLED) according to an exemplary embodiment of the present invention, the active matrix OLED including a plurality of pixel units.

FIG. 2 is a flowchart summarizing an exemplary method for fabricating the active matrix OLED of FIG. 1.

FIG. 3 is a side cross-sectional view relating to a step of providing a doped semiconductor layer on a transparent insulating substrate according to the method of FIG. 2.

FIG. 4 is a side cross-sectional view relating to a step of providing a first insulating layer on the transparent insulating substrate and the doped semiconductor layer according to the method of FIG. 2.

FIG. 5 is a side cross-sectional view relating to a step of providing a gate electrode layer on the first insulating layer according to the method of FIG. 2.

FIG. 6 is a side cross-sectional view relating to a step of providing a second insulating layer on the gate electrode layer and the first insulating layer according to the method of FIG. 2.

FIG. 7 is a side cross-sectional view relating to a step of forming a first contact hole and a second contact hole through the two insulating layers according to the method of FIG. 2.

FIG. 8 is a side cross-sectional view relating to a step of providing a source electrode and a drain electrode filling the two contact holes, respectivley, according to the method of FIG. 2.

FIG. 9 is a side cross-sectional view relating to a step of providing a passivation layer on the second insulating layer, the source electrode, a portion of the drain electrode according to the method of FIG. 2.

FIG. 10 is a side cross-sectional view relating to a step of providing an organic emission structure on the other portion of the drain electrode according to the method of FIG. 2.

FIG. 11 is a side cross-sectional view of part of a conventional active matrix OLED.

### DETAILED DESCRIPTION OF PREFERRED EMBODIMENTS

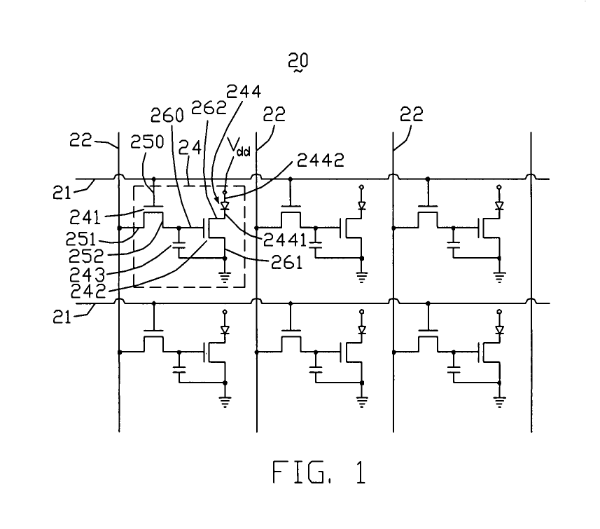

Referring to FIG. 1, certain parts of an active matrix organic light emitting display (OLED) 10 according to an exemplary embodiment of the present invention are shown. The active matrix OLED 20 includes a plurality of scan lines 21 that are parallel to each other and that each extend along a first direction, and a plurality of data lines 22 that are parallel to each other and that each extend along a second direction that is orthogonal to the first direction. A smallest rectangular area formed by any two adjacent scan lines 21 together with any two adjacent data lines 22 defines a pixel unit 24 thereat. Each pixel unit 24 includes a first thin film transistor (TFT) 241, a second TFT 242, a storage capacitor 243, and an organic emission structure 244. In the active matrix OLED 20, the first TFTs 241 operate as switching elements of the second TFTs 242, and the second TFTs 242 operate as switching elements of the organic emission structures 244. In each pixel unit 24, the storage capacitor 243 is used to store electrical power for the organic emission structure 244.

In each pixel unit 24, the first TFT 241 includes a first gate electrode 250, a first source electrode 251, and a first drain electrode 252. The second TFT 242 includes a second gate electrode 260, a second source electrode 261, and a second drain electrode 262. The organic emission structure 244 includes a cathode 2441 and an anode 2442. The first gate electrode 250 is connected with the corresponding scan line 21. The first source electrode 251 is connected with the corresponding data line 22. The first drain electrode 252 is connected with the second gate electrode 260. The second source electrode 261 is grounded. The second drain electrode 262 is connected with the cathode 2441 of the organic emission structure 244. The anode 2442 is connected to an external power Vdd. The storage capacitor 243 connects the second gate electrode 260 to ground.

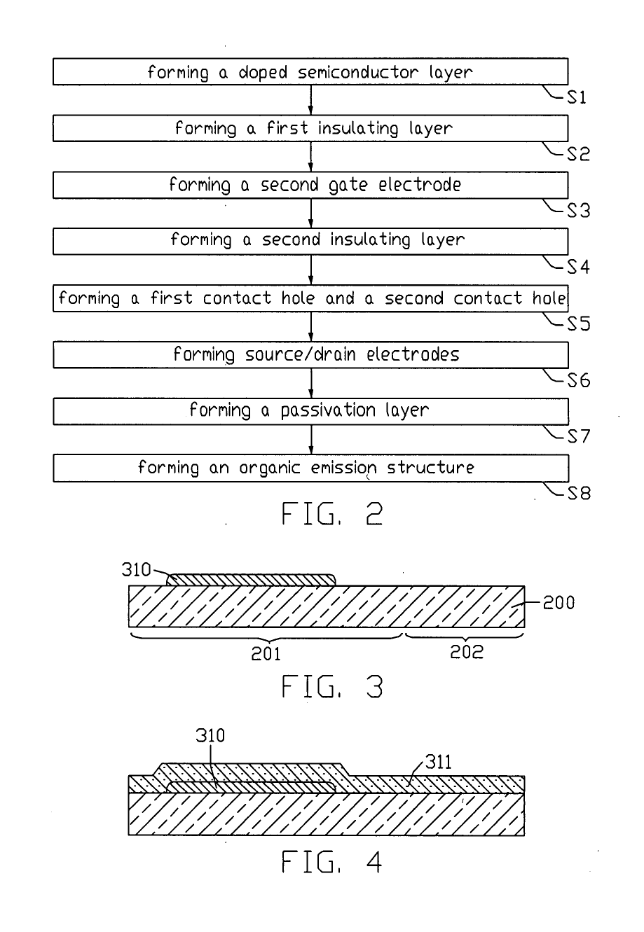

Referring to FIG. 2, this is a flowchart summarizing an exemplary method for fabricating the active matrix OLED 10. The method includes: step S1, forming a doped semiconductor layer; step S2, forming a first insulating layer; step S3, forming a second gate electrode; step S4, forming a second insulating layer; step S5, forming a first contact hole and a second contact hole; step S6, forming source/drain electrodes; step S7, forming a passivation layer; and step S8, forming an organic emission structure.

In step S1, referring to FIG. 3, a transparent insulating substrate 200 is provided. The transparent insulating substrate 200 may be made from glass or quartz. The transparent insulating substrate 200 includes a TFT region 201 and an organic emission region 202. A poly-silicon layer is deposited on the transparent insulating substrate 200. The poly-silicon layer is patterned into an island-shape on the TFT region 201, and then the island-shaped poly-silicon layer is doped, thereby forming an a doped island-shaped semiconductor layer 310.

In step S2, referring to FIG. 4, a first insulating layer 311 is deposited on the doped semiconductor layer 310 and the transparent insulating substrate 200 by a chemical vapor deposition (CVD) process. The first insulating layer 311 can be made from amorphous silicon nitride (SiNx) or silicon dioxide (SiO₂).

In step S3, referring to FIG. 5, a gate metal layer and a first photo-resist layer (not shown) are sequentially formed on the first insulating layer 311. The gate metal layer can be made from material including any one or more items selected from the group consisting of aluminum (Al), molybdenum (Mo), copper (Cu), chromium (Cr), and tantalum (Ta).

An ultraviolet (UV) light source (not shown) and a first photo-mask (not shown) are used to expose the first photo-resist layer. Then the exposed first photo-resist layer is developed, thereby forming a first photo-resist pattern. Using the first photo-resist pattern as a mask, portions of the gate metal layer which are not covered by the first photo-resist pattern are etched away, thereby forming a gate electrode 312. The first photo-resist pattern is then removed by using an acetone solution.

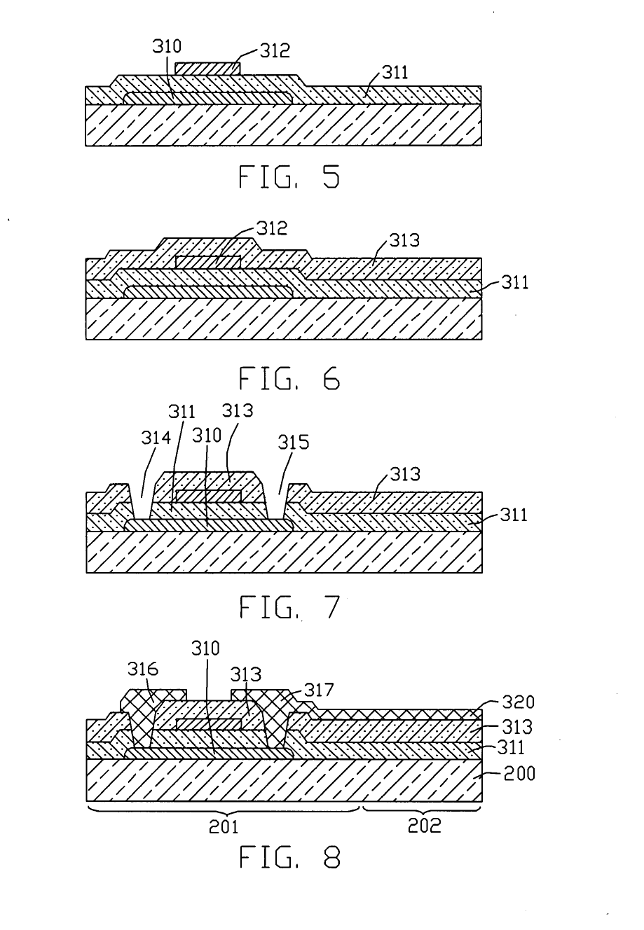

In step S4, referring to FIG. 6, a second insulating layer 313 is deposited on the first insulating layer 311 and the gate electrode 312. The second insulating layer 313 can be made from amorphous silicon nitride (SiNx) or silicon dioxide (SiO₂).

In step S5, referring to FIG. 7, a second photo-resist layer (not shown) is coated on the second insulating layer 313. The ultraviolet (UV) light source and a second photo-mask (not shown) are used to expose the second photo-resist layer. Then the exposed second photo-resist layer is developed, thereby forming a second photo-resist pattern. Using the second photo-resist pattern as a mask, portions of the second insulating layer 313 and the first insulating layer 311 which are not covered by the second photo-resist pattern are etched away. Thereby, a first contact hole 314 and a second contact hole 315 are defined through said portions, with two ends of the doped semiconductor layer 310 being exposed. The second photo-resist pattern is then removed by using an acetone solution.

In step S6, referring to FIG. 8, a source/drain metal layer and a third photo-resist layer (not shown) are sequentially formed on the second insulating layer 313 and the doped semiconductor 310. The source/drain metal layer can be made from material including any one or more items selected from the group consisting of aluminum (Al), and argentine (Ag).

The third photo-resist layer is exposed by a third photo-mask, and then is developed, thereby forming a third photo-resist pattern. Using the third photo-resist pattern as a mask, portions of the source/drain metal layer which are not covered by the third photo-resist pattern are etched away by one or more concentrated acid solutions, thereby forming a source electrode 316 and a drain electrode 317. The third photo-resist pattern is then removed by using an acetone solution. The source electrode 316 and the drain electrode 317 fill the first contact hole 314 and the second contact hole 315 respectively, and are electrically connected with the doped semiconductor layer 310. The source electrode 316 and the drain electrode 317 further cover a portion of the second insulating layer 313. A part of the drain electrode 317 covering the second insulating layer 313, corresponding to the organic emission region 202, is configured as a cathode reflective layer 320. The one or more concentrated acid solutions can for example be either or both of a nitric acid (HNO₃) solution and an acetic acid (C₂H₄O₂) solution.

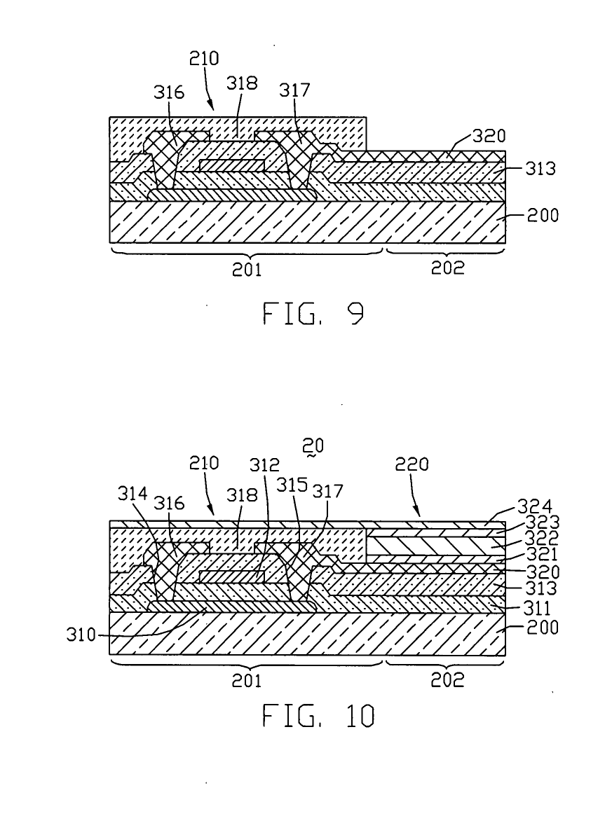

In step S7, referring to FIG. 9, a passivation layer (not shown) and a fourth photo-resist layer (not shown) are sequentially formed on the source electrode 316, the drain electrode 317, and the second insulating layer 313. The passivation layer is made from an organic light sensitive material having a high photosensitivity, which can be formed by a spin coating process or a spraying coating process. The passivation layer has a smooth upper surface.

The fourth photo-resist layer is exposed by a fourth photo-mask, and then is developed, thereby forming a fourth photo-resist pattern. Using the fourth photo-resist pattern as a mask, a portion of the passivation layer corresponding to the organic emission region 202 is etched away to expose the cathode reflective layer 320. A residual portion of the passivation layer corresponding to the TFT region 201 is configured as a cathode inter-insulator 318.

After step S7 has been completed, a TFT structure 210 is formed on the TFT region 201, with the cathode reflective layer 320 of the active matrix OLED 20 provided on the organic emission region 202.

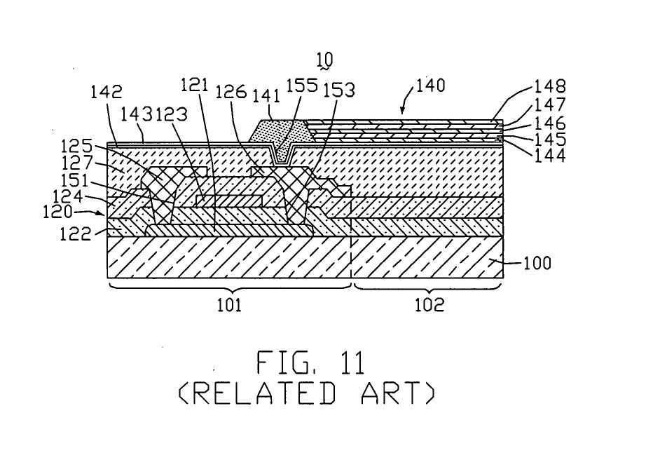

In step S8, referring to FIG. 10, an electron injection layer (EIL) 321, an organic emission layer (EL) 322, a hole injection layer (HIL) 323, and a transparent anode 324 covering the whole surface of the HIL 323 and the cathode inter-insulator 318 are sequentially formed on the cathode reflective layer 320, in that order from bottom to top. A combined thickness of the HIL 323, the organic EL 322, and the EIL 321 is substantially equal to a thickness of the cathode inter-insulator 318. Thus, an organic emission structure 220 is formed.

The HIL 323 can be made from copper phthalocyanine (CuPc). The EIL 321 can be made from alkali metals or alkali earth metals with low work function, such as lithium fluoride (LiF), compounds of calcium (Ca), or magnesium (Mg). The organic EL 322 can for example be made from polymeric electroluminescence material, which is deposited by a spin on deposition (SOD) process or an inkjet printing process. The polymeric electroluminescence material can be para-phenylenevinylene (PPV). The organic EL 322 can instead be made from small molecular compounds, which are deposited by a vacuum vapor deposition (VVD) process. The small molecular compounds can be diamine compounds.

Referring to FIG. 10, the active matrix OLED 20 includes a transparent insulating substrate 200 defining the thin film transistor (TFT) region 201 and the organic emission region 202 continuously distributed, the TFT structure 210 corresponding to the TFT region 201, and the organic emission structure 220 corresponding to the organic emission region 202.

The TFT structure 210 includes the doped semiconductor layer 310, the first insulating layer 311, the gate electrode 312, the second insulating layer 313, the source electrode 316, the drain electrode 317, and the passivation layer. The doped semiconductor layer 310 is island-shaped, and is disposed on the TFT region 201. The first insulating layer 311 covers the doped semiconductor layer 310 and the transparent insulating substrate 200. The gate electrode 312 is formed on the portion of the first insulating layer 311 that corresponds to the doped semiconductor layer 310. The second insulating layer 313 covers the gate electrode 312 and the first insulating layer 311.

The first insulating layer 311 and the second insulating layer 313 cooperatively define the first contact hole 314 and the second contact hole 315 therethrough. Thereby, the first and second contact holes 314, 315 expose two parts of the doped semiconductor 310, respectively. The source electrode 316 and the drain electrode 317 fill the two contact holes 314, 315, respectively, and each of the source and drain electrodes 316, 317 overlaps a respective portion of the second insulating layer 313. The part of the drain electrode 317 corresponding to the organic emission region 202 is defined as the reflective cathode layer 320. The source electrode 316 and the drain electrode 317 are electrically connected with the doped semiconductor layer 310. The passivation layer covers the source electrode 316, the drain electrode 317, and the second insulating layer 313, for protecting the TFT structure 210. The passivation layer also is defined as the cathode inter-insulator 318.

The organic emission structure 220 includes the electron injection layer (EIL) 321, the organic emission layer (EL) 322, the hole injection layer (HIL) 323, and the transparent anode 324 covering the whole surface of the HIL 323 and the cathode inter-insulator 318, sequentially formed on the cathode reflective layer 320, in that order from bottom to top. A combined thickness of the HIL 323, the organic EL 322, and the EIL 321 is substantially equal to a thickness of the cathode inter-insulator 318.

When a voltage is provided on the active matrix OLED 20, the HIL 323 and the EIL 321 respectively inject electric holes and electrons into the organic EL 322 for hole-electron combination. The electrons and the electric holes meet and bond, thus both returning a basic state from an excited state. Energy radiates in the form of rays. One part of this light then escapes through the HIL 323, and the transparent anode 324 where the viewer can observe it; and another part of this light is reflected through the HIL 323, and the transparent anode 324 by the cathode reflective layer 320.

Unlike with conventional active matrix OLEDs and methods for fabricating conventional active matrix OLEDs, the transparent anode 324 is formed at a top portion of the organic emission structure 220, and the reflective cathode layer 320 is disposed at a bottom portion thereof. Thus a top emission mode is realized. Furthermore, the transparent anode 324 is made from transparent material. Thus a good transpanrence and a good luminance of the active matrix OLED 20 can be assured. Moreover, the part of the drain electrode 317 of the active matrix OLED 20 is defined as the reflective cathode layer 320. Thus there is not need for a process of forming a contact hole in order to electrically connect the drain electrode 317 and the reflective cathode layer 320. In addition, the residual portion of the passivation layer used for protecting the TFT structure 210 is also used as the cathode inter-insulator 318. Thereby, there is no need for a separate process of fabricating the cathode inter-insulator 318. For these reasons, the method for fabricating the active matrix OLED 20 is simplified, and the cost of fabricating the active matrix OLED 20 is reduced. Further, the structure of the active matrix OLED 20 is simplified.

Besides, the EIL 321 is disposed under the organic EL 322, and the transparent anode 324, which are made from organic material. So, the structure can avoid the hydrosphere permeating and oxidizing the EIL 321. Therefore, the reliability of the active matrix OLED 20 is improved.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An active matrix organic light emitting display (OLED) comprising:
a transparent insulating substrate;
a thin film transistor (TFT) structure formed on the transparent insulating substrate, the TFT structure comprising:
a source electrode,
a drain electrode, and
a passivation layer covering the source electrode and a portion of the drain electrode, the passivation layer configured as a cathode inter-insulator; and
an organic emission structure formed on another part of the drain electrode configured as a reflective cathode layer.

2. The active matrix OLED as claimed in claim 1, wherein the TFT structure further comprises a doped semiconductor layer formed on the transparent insulating substrate, a first insulating layer formed on the doped semiconductor layer and the transparent insulating substrate, a gate electrode formed on a portion of the first insulating layer that corresponds to the doped-semiconductor layer, and a second insulating layer formed on the gate electrode and the first insulating layer.

3. The active matrix OLED as claimed in claim 2, wherein the first insulating layer and the second insulating layer cooperatively define two contact holes, and the source electrode and the drain electrode which are formed on the second insulating layer are electrically connected with the doped semiconductor through the two contact holes, respectively.

4. The active matrix OLED as claimed in claim 2, wherein the source electrode and the drain electrode are formed on the second insulating layer.

5. The active matrix OLED as claimed in claim 1, wherein the source electrode and the drain electrode are made from material having high reflectivity comprising any one or more items selected from the group consisting of aluminum, and argentine.

6. The active matrix OLED as claimed in claim 1, wherein the organic emission structure further comprises an electron injection layer (EIL), an organic emission layer (EL), a hole injection layer (HIL), and a transparent anode covering the whole surface of the HIL and the cathode inter-insulator, which are sequentially formed on the cathode reflective layer, in that order from bottom to top.

7. The active matrix OLED as claimed in claim 6, wherein a combined thickness of the hole injection layer, the organic emission layer, and the electron injection layer is substantially equal to a thickness of the passivation layer.

8. The active matrix OLED as claimed in claim 6, wherein the hole injection layer is made from copper phthalocyanine.

9. The active matrix OLED as claimed in claim 6, wherein the organic emission layer is made from polymeric electroluminescence material.

10. The active matrix OLED as claimed in claim 6, wherein the organic emission layer is made from one or more diamine compounds.

11. The active matrix OLED as claimed in claim 6, wherein the electron injection layer is made from alkali metals or alkali earth metals with low work function.

12. A method for fabricating an active matrix organic light emitting display (OLED), the method comprising:
providing a transparent insulating substrate;
forming a thin film transistor (TFT) structure on the transparent insulating substrate, comprising:
forming a source electrode and a drain electrode, and
forming a passivation layer covering the source electrode and a portion of the drain electrode;
forming an organic emission structure on the other portion of the drain electrode.

13. The method as claimed in claim 12, wherein the step of forming the TFT structure further comprises: forming a doped semiconductor layer, a first insulating layer, a gate electrode, a second insulating layer in sequence, and forming the source electrode and the drain electrode on the second insulating layer.

14. The method as claimed in claim 13, wherein the step of forming the doped semiconductor layer comprises: depositing a poly-silicon layer on the transparent insulating substrate, patterning the poly-silicon layer.

15. The method as claimed in claim 13, wherein the step of forming the gate electrode comprises: depositing a gate mental layer on the first insulating layer, and patterning the gate mental layer to form a gate electrode by a photolithograph process.

16. The method as claimed in claim 13, wherein the step of forming the second insulating layer comprises: forming two contact holes each cutting through the first insulating layer and the second insulating layer to expose the doped semiconductor layer, respectively.

17. The method as claimed in claim 16, wherein the step of forming the source electrode and the drain electrode comprises: depositing a source/drain mental layer on the second insulating layer and the doped semiconductor layer, and patterning the source/drain mental layer to form the source electrode and the drain electrode corresponding to the two contact holes, respectively.

18. The method as claimed in claim 12, wherein the step of forming the organic emission structure further comprises: forming a hole injection layer, a hole transfer layer, an organic emission layer, an electron transfer layer, and an electron injection layer in sequence on the transparent electrode layer, and forming a cathode reflective layer on the electrode injection layer and the passivation layer.

19. The method as claimed in claim 18, wherein the organic emission layer is made from polymer electroluminescence material, and the hole injection layer is made from copper phthalocyanine, and the hole transfer layer is made from ployaniline or triaromatic derivatives, and the electron injection layer is made from alkali metals or alkali earth metals.
